(19) United States
(12) Patent Application Publication
(10) Pub. No.: US 2020/0247484 A1
(43) Pub. Date: Aug. 6, 2020

(54) Tailgate Conversion

(71) Applicant: Lime Media Group, Inc., Rowlett, TX (US)

(72) Inventor: Robert FLEMING, Rowlett, TX (US)

(21) Appl. No.: 16/781,498

(22) Filed: Feb. 4, 2020

Related U.S. Application Data
(60) Provisional application No. 62/801,448, filed on Feb. 5, 2019.

(51) Int. Cl. B62D 33/03

(52) U.S. Cl. CPC B62D 33/03

(57) ABSTRACT

A system and method for converting a horizontal swing tailgate to a fold down tailgate. The conversion system includes a replacement fold down tailgate, a hinge, and latch receivers. The hinge has a tailgate coupling portion and a vehicle coupling portion. The latch receivers are installed to coincide with the location of the latch.

### PRIORITY

The present invention claims priority to U.S. Provisional No. 62/801,448 filed Feb. 5, 2019, the entirety of which is hereby incorporated by reference.

### BACKGROUND OF THE INVENTION

### Technical Field

The present invention relates to a system and method for converting a tailgate.

### Description of Related Art

Many vehicles, such as Jeeps, have a tailgate which swings open rather than folds down like a tailgate for a tuck. Many consumers prefer a fold down tailgate. Consequently, there is a need for a system and method to allow for a conversion to a fold down tailgate.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a perspective view of a tailgate in the closed position in one embodiment;

FIG. 2 is a perspective view of a tailgate in an open position in one embodiment;

FIG. 3 is an inner top perspective view of a tailgate in one embodiment;

FIG. 4 is an outer perspective view of a tailgate in one embodiment;

FIG. 5 is an exploded view of a tailgate in one embodiment;

FIG. 6 is a perspective view of a hinge in one embodiment.

### DETAILED DESCRIPTION

Several embodiments of Applicant's invention will now be described with reference to the drawings. Unless otherwise noted, like elements will be identified by identical numbers throughout all figures. The invention illustratively disclosed herein suitably may be practiced in the absence of any element which is not specifically disclosed herein.

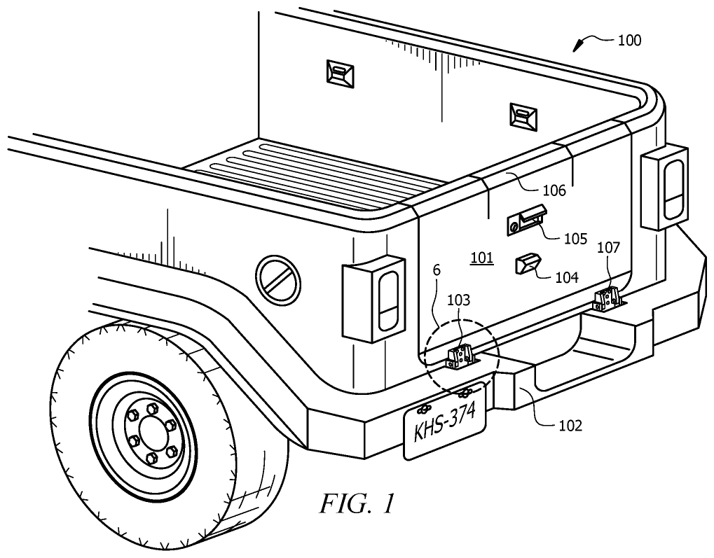

FIG. 1 is a perspective view of a tailgate 101 in the closed position in one embodiment. As used herein, a tailgate is an item which moves from an open to a closed position and which provides access into a vehicle. Tailgates can pivot from hinges located on the side such that they open and shut in the same plane as a car door. These are referred to as horizontal swing tailgates. In other embodiments, tailgates can pivot from an upright closed position to a horizontal open position. Such tailgates are referred to as fold down tailgates.

The tailgate 101 can have virtually any material and any color. In one embodiment the tailgate 101 is substantially hollow and comprises a metal frame, as discussed in more detail below herein.

FIG. 1 also shows a vehicle 100. The vehicle can comprise virtually any vehicle. In one embodiment the vehicle initially has a horizontal swing tailgate which is to be converted to a fold down tailgate. In one embodiment the vehicle comprises a Jeep which are known for their horizontal swing tailgates. In one specific embodiment, the vehicle 100 comprises a Jeep JL.

The tailgate 101 depicted has a shorter width than the width of the vehicle 100. Put differently, the tailgate 101 does not take the entire width of the vehicle. Instead, the vehicle lights, for example, are still on both sides of the tailgate 101.

As shown, the tailgate 101 has a handle 105. As used herein a handle 105 refers to a mechanism or device which upon manipulation can open a tailgate. The handle 105 can comprise a button, a lever, etc. While shown as being located in the center of the tailgate, this is for illustrative purposes only and should not be deemed limiting.

In one embodiment, and as depicted, the tailgate 101 has a camera 104. This allows the driver to see when they are backing up, parking, etc.

The tailgate 101 has a tailgate top 106 and a tailgate bottom 107. In one embodiment, the tailgate bottom 107 is coupled to a hinge 103. The hinge 103, discussed in more detail below, couples the tailgate 101 to the vehicle body 100. In other embodiments, however, the tailgate 101 can be coupled to the vehicle at the tailgate top 106.

As depicted, below the tailgate 101 is the bumper 102. The bumper 102, in some embodiments, is the same stock bumper 102 that was manufactured with the vehicle 101. In one embodiment the bumper 102 needs to be removed to installed the tailgate 101. In other embodiments, however, a cutaway 114 can be made in the bumper 102 such that the bumper 102 does not have to be removed for installation of the tailgate 101. As discussed in more detail below, the cutaway 114 allows the hinge 103 to be stalled.

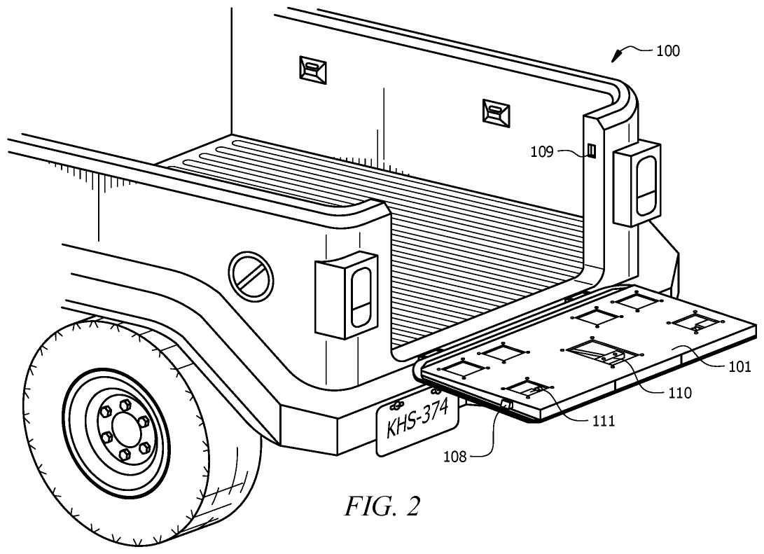

Turning to FIG. 2, FIG. 2 is a perspective view of a tailgate in an open position in one embodiment. In contrast to the closed position of FIG. 1, the tailgate 101 in the open position is parallel to the length of the vehicle. When in the closed position of FIG. 1, the tailgate 101 is parallel with the width of the vehicle. Thus, in one embodiment the tailgate 101 in the open position is approximately perpendicular to the tailgate 101 in the closed position. In one embodiment the tailgate 101 rotates about 90 degrees between the open position and the closed position.

The finish layer of the tailgate 101, the side which faces the interior of the vehicle, has been removed to illustrate the closing and locking mechanisms. As can be seen, in the embodiment depicted, the tailgate 101 is largely hollow. This allows for reduction of weight, and increasing of fuel efficiency of the vehicle. It also allows for easier manipulation of the tailgate 101 compared to heavier tailgates 101.

FIG. 2 depicts a lever 110. The lever 110, as shown, is located approximately in the middle of the tailgate 101. The lever 110 is coupled to the handle 105 such that when the handle 105 is manipulated, the lever 110 responds.

The lever 110, as depicted, rotates to control the movement of the latches 108. The latches 108 extend and lock with the latch receiver 109 located on the vehicle to secure the tailgate 101 in place. In one embodiment the lever 110 is coupled to a latch coupler 111 when extends to each latch 108 and the lever 110. When the lever 110 is rotated, this pulls the latch coupler 111 and thus the latch 108 inward. When the lever 110 is released, the coupler 111 and the latch 108 urge back to their extended position. In one embodiment the lever, the coupler 111, and/or the latch 108 are under pressure, such as via a spring, to achieve the extended position. Thus, unless a force is applied to the lever 110, the latches 108 will extend to their outward, extended location.

As noted, in one embodiment, the lever 110 is coupled to two latch couplers 111 which are each coupled to a latch 108. The latches 108 are moveable from a retracted inwardly position to an extended outwardly position in response to manipulation of the lever 110. In the retracted inwardly position, the latches 108 do not engage with the latch receiver 109. Thus, the tailgate is free to be pulled into the open position. When the latches 109 are in the extended outwardly position, and if properly aligned with the latch receivers 109, the tailgate is prevented from rotating.

In one embodiment the latch couplers 111 are elongated members which couple with the lever 110. As shown, there are two latch couplers 111 extending in opposite directions from the centralized lever 110. When the lever 110 is rotated, the latches 108 are pulled or pushed in opposite directions.

The latch receiver 109 can comprise any receiver which will engage and secure the latch 108. In one embodiment the latch receiver 109 is a void with necessary equipment to house and secure the latch 108. In one embodiment the receiver 109 is similar to the void in a door frame which receives the door latch.

In one embodiment holes are drilled into the vehicle body and a latch receiver 109 is installed. The latch receiver 109 is installed in such a location that it will coincide with the location of the latch 108.

While one embodiment describing a lever 110 and latches 108 have been described, this is for illustrative purposes only and should not be deemed limiting. The tailgate 101 can comprise any latching mechanism or device used on current tailgates. Further, the tailgate 101 can further comprise a locking mechanism whereby the user can lock the tailgate 101 in the open or closed position.

As can be seen from FIG. 2, when in the open position, the tailgate 101 functions as any other tailgate 101. The tailgate 101 can have virtually any other accessory found on other tailgates 101 such as attached steps, ladders, etc.

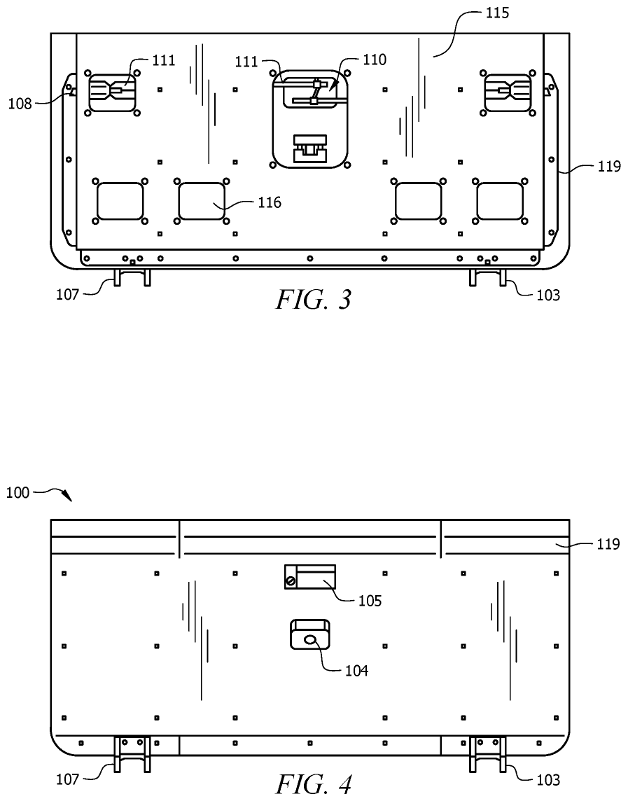

FIG. 3 is an inner top perspective view of a tailgate in one embodiment. Like FIG. 2, the finish layer has been removed so as to see the internals. As shown, the lever 110 is shown coupled to the latch couplers 111 which extend to the latches 108. In this embodiment, the latches 108 are in their retracted position whereby they are not extending beyond, or will not otherwise engage with the respective latch receivers 109.

The tailgate 101 shows the frame body 115 attached to the outer skin 119. The frame body 115 provides structure and rigidity to the tailgate. In one embodiment the frame body 115 is not visible on an installed tailgate. Instead, the frame body 115 is sandwiched between two finished layers. The finished layers can comprise an outer skin 119 which is visible to the consumer. The outer skin 119 can be painted like typical auto bodies.

The frame body 115 can comprise virtually any material. In one embodiment the frame body 115 comprises metal. As shown the frame body 115 comprises at least one cutout 116. A cutout 116 is a void or window in the frame body 115. The cutout 116 serves multiple functions. The cutout 116 can act to reduce weight of the tailgate. Further, the cutout 116 can provide a window in which the underlying components, such as the lever 110, are visible. This provides access to repair or adjust the internal components of the tailgate 101.

Also depicted in FIG. 3 is a portion of the hinge 103. As can be seen, the hinge 103 is secured to the tailgate via three bolts. This is for illustrative purposes only and should not be deemed limiting.

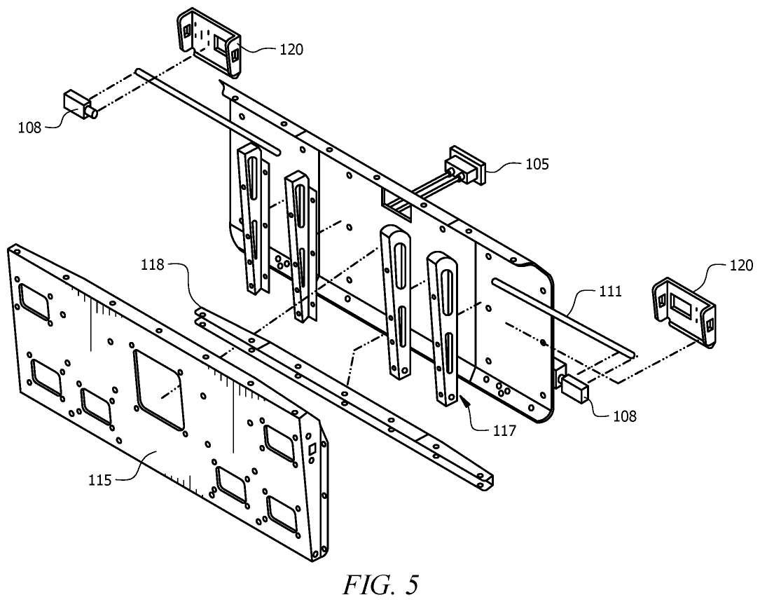

FIG. 4 is an outer perspective view of a tailgate in one embodiment. In this embodiment the outer skin 119 is visible. The partial hinges 103 are also visible at the bottom of the tailgate 101. Further the handle 105 and the camera 104 are also visible.

FIG. 5 is an exploded view of a tailgate in one embodiment. This figure shows one non-limiting example of how the frame body 115 can be coupled to the outer skin 119 to make the tailgate 101. As seen, sandwiched between the frame body 115 and the outer skin 119 are the frame struts 117. In one embodiment these are elongated members which add structure and rigidity to the tailgate 101. By having struts 117 and a frame body 115 as opposed to a solid frame, the weight of the frame can be reduced. The struts 117 can comprise virtually any material including metal, plastics, and combinations therein.

The struts 117 can be sized and spaced to meet collision requirements and standards. As depicted there are four structs vertically oriented parallel with the height of the tailgate 101. They are spaced along the width of the tailgate.

As depicted the struts 117 have cutouts 116 in the struts 117 which further allow weight to be reduced. The struts 117 can be coupled to the outer skin 119 and the frame body 115 via any method or device known in the art. This includes welding, soldering, screws, bolts, etc.

Aside from the struts 117, there is an additional bottom brace 118 in some embodiments. The bottom brace 118 can couple to the struts 117, the frame body 115, and/or the outer skin 119. The bottom brace 118 provides an additional opportunity to provide increased structure and support in the tailgate 101 as well as provide additional coupling between the components.

FIG. 5 also shows the latch couplers 111 and how they can be releaseably coupled with the latches 108. Finally, FIG. 5 also shows latch guide 120. The latch guide 120 is a component which can be coupled to the frame body 115 or the outer skin 119. The latch guide 120 seeks to guide the latches 108 and maintain them in the desired location.

In one embodiment, and as depicted, the outer skin 119 has an upper lip and a lower lip which are adjacent to the top and bottom of the struts 117. The lips offer an additional opportunity to couple the outer skin 119 to the struts 117.

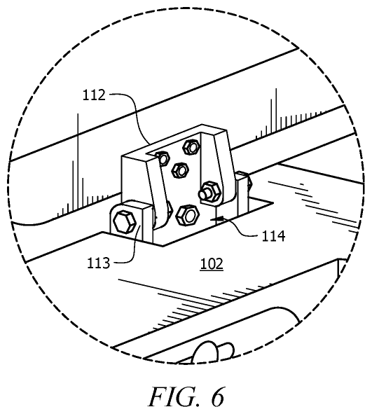

FIG. 6 is a perspective view of a hinge in one embodiment. In this embodiment there are two hinges 103—one on each end of the tailgate 101. This is for illustrative purposes and should not be deemed limiting. In other embodiments, for example, there may be more or fewer hinges 103 placed at various locations.

The hinge 103 couples the tailgate 101 to the vehicle 100. In the embodiment depicted the hinge 103 is two sections joined by a hinge point. The first section is the tailgate coupler 112. The tailgate coupler 112 is coupled to the tailgate 101 by any method or device known in the art. This can include, but is not limited to, bolts, screws, welding, soldering, etc. As shown the tailgate coupler 112 is coupled to the tailgate 101 via three bolts. The bolts coupler the tailgate coupler 112 portion of the hinge 103 to the tailgate 101.

Coupled to the tailgate coupler 112 via a hinge point is a vehicle coupler 113. The vehicle coupler 113 acts similar to the tailgate coupler 112 but it is coupled to the vehicle 100. Thus, there is a portion of the hinge 103 which is coupled to the tailgate 101, and a portion of the hinge 103 which is coupled to the vehicle 100. The tailgate 101 can rotate via the hinge at the hinge point.

While one example hinge has been illustrated and described, this is for illustrative purposes only and should not be deemed limiting. There are other types of hinges which will be suitable for operation in the tailgate.

As depicted a cutaway 114 has been made in the bumper 102. This is a void in the bumper 102 which provides access for the hinge 103 to swivel and/or the hinge 103 to be installed.

The tailgate system described allows a previously horizontal swing tailgate to be converted to a fold down tailgate. There are many reasons why a user will prefer a fold down tailgate to a horizontal swing tailgate. First, a fold down tailgate when in the open position provides increased surface area on which to sit, hold or display objects, etc. This surface area is not available in a horizontal swing tailgate. Second, access to a horizontal swing tailgate is limited to one specific side whereas the fold down tailgate provides access across the width of the tailgate. Third, an operator has to ensure there is amble space to the side of the vehicle to allow for the horizontal swing tailgate to open. If another vehicle is parked too close to the side, opening the tailgate is limited. Conversely, with a fold down tailgate, the operator need not worry about items on each side.

Now that a system for a tailgate has been described, the method of converting a horizontal swing tailgate to a fold down tailgate will be described. First, the old swinging tailgate is removed. Next, a fold down tailgate is obtained. The fold down tailgate, in one embodiment, has a frame body coupled to an outer skin and the tailgate has at least one latch.

Thereafter, the user will determine the correct location of the at least one latch receiver 109 to match and coincide with the latch 108. If necessary, the user will drill holes and install the latch receiver 109 at the specific height to receive the latch 108. In embodiments with two latches 108, two latch receivers 109 are installed.

Next, the user will couple the tailgate to the vehicle. In one embodiment the user will install the hinge 103 and couple the hinge 103 to the vehicle. As noted, in some embodiments the bumper 102 will need to be removed, but in other embodiments removing the bumper 102 is not necessary.

In some embodiments the tailgate conversion can be completed with minimal modification to the vehicle. In one embodiment the extent of the modification involves drilling holes for the hinge 103 and the latch receiver 109. In some embodiments this is the only modification to the vehicle. In one embodiment the user is required to cut a cutaway into the bumper to provide access for the hinge.

While the invention has been particularly shown and described with reference to a preferred embodiment, it will be understood by those skilled in the art that various changes in form and detail may be made therein without departing from the spirit and scope of the invention.

What is claimed is:

1. A system for a tailgate conversion, said system comprising:
a fold down tailgate;
a hinge;
latch receivers; and wherein said fold down tailgate comprises a frame body coupled to an outer skin.

2. The system of claim 1 wherein said fold down tailgate is installed in a vehicle which previously had a horizontal swing tailgate.

3. The system of claim 1 further comprising a lever coupled to two latch couplers, wherein each of said latch couplers is coupled to a latch, wherein said frame body comprises a cutout adjacent to said lever, and wherein said latches move from a retracted inwardly position to an extended outwardly position in response to manipulation of said lever.

4. The system of claim 3 wherein said latch couplers are elongated members which extend in opposite directions away from said lever.

5. The system of claim 3 further comprising latch receivers sized to receive said latches when in said extended outwardly position.

6. The system of claim 5 wherein said latch receives are installed in a vehicle.

7. The system of claim 1 wherein said tailgate is moveable from a closed position wherein said tailgate is vertical, to an open position wherein said tailgate is horizontal, and wherein when in said closed position, said hinges are located at the bottom of said tailgate.

8. The system of claim 1 further comprising frame struts located between said frame body and said outer skin.

9. The system of claim 1 further comprising a bottom brace which couples to the bottom of each of said frame struts.

10. The system of claim 1 wherein said frame body comprises at least one cutout.

11. The system of claim 1 wherein said hinge comprises a vehicle coupler coupled to a tailgate coupler.

12. A method for tailgate conversion, said method comprising:
removing a swinging tailgate;
obtaining a fold down tailgate, wherein said fold down tailgate comprises a frame body coupled to an outer skin, and wherein said tailgate comprises at least one latch;
installing at least one latch receiver on a vehicle to coincide with the location of said at least one latch;
coupling said fold down tailgate to said vehicle.

13. The method of claim 12 wherein said fold down tailgate comprises two latches, and further comprises a lever coupled to two latch couplers, wherein each of said latch couplers is coupled to a latch, and wherein said latches move from a retracted inwardly position to an extended outwardly position in response to manipulation of said lever.

14. The method of claim 13 wherein said latch couplers are elongated members which extend in opposite directions away from said lever, wherein said installing step comprises installing at least two latch receivers, and wherein said latch receivers are sized to receive said latches when in said extended outwardly position.

15. The method of claim 12 wherein said coupling comprises installing a vehicle coupler on said vehicle, and coupling said vehicle coupler to a tailgate coupler which is coupled to said tailgate, wherein said vehicle coupler and said tailgate coupler form a hinge which allows the fold down tailgate to pivot about said hinge.

16. The method of claim 15 wherein the only modification to said vehicle is installation of said hitcher receiver and coupling said vehicle coupler to said vehicle.

17. The method of claim 15 wherein said coupling comprises placing a cutaway in a bumper located on said vehicle, wherein said cutaway provides access for said hinge.

18. The method of claim 12 wherein said vehicle comprises a Jeep.
